(19) United States
(12) Patent Application Publication
(10) Pub. No.: US 2020/0270157 A1
(43) Pub. Date: Aug. 27, 2020

(54) SYSTEM AND METHOD FOR DESALINATING AND REMOVING POLLUTANTS FROM PRODUCED WATER

(71) Applicant: GAS TECHNOLOGY INSTITUTE, DES PLAINES, IL (US)

(72) Inventors: John C. VEGA III, Camarillo, CA (US); Sarah EISENLORD, Libertyville, IL (US); James SEABA, Barrington, IL (US)

(73) Assignee: GAS TECHNOLOGY INSTITUTE, DES PLAINES, IL (US)

(21) Appl. No.: 16/797,857

(22) Filed: Feb. 21, 2020

Related U.S. Application Data
(60) Provisional application No. 62/808,649, filed on Feb. 21, 2019.

(51) Int. Cl. C02F 9/00; B01D 5/00; B01D 45/12; B01D 50/00

(52) U.S. Cl. CPC C02F 9/00; B01D 5/006; C02F 2103/10; B01D 45/12; B01D 50/002; B01D 5/009

(57) ABSTRACT

A system and method for desalinating and removing pollutants from water produced during oil and gas development that includes a discharge directing produced water from a well and a direct contact steam generator positioned downstream of the discharge. A filter is positioned downstream of the direct contact steam generator to separate solid waste from the produced water and a condenser is positioned downstream of the filter, the condenser separating combustion exhaust from clean water.

### CROSS REFERENCE TO RELATED APPLICATION

This application claims the benefit of U.S. Provisional patent application, Ser. No. 62/808,649, filed on 21 Feb. 2019. The co-pending Provisional application is hereby incorporated by reference herein in its entirety and is made a part hereof, including but not limited to those portions which specifically appear hereinafter.

### BACKGROUND OF THE INVENTION

### Field of the Invention

The invention is directed to a method for desalinating and removing pollutants from water produced during oil and gas development.

### Description of Related Art

The unconventional oil and gas production boom has revolutionized the U.S. oil and gas industry, significantly increasing domestic production while lowering imports and promoting energy independence. Shale resources and hydraulic fracturing are key components to reducing our dependence on foreign energy. As of 2016, a total of 670,000 of the 977,000 operating wells in the U.S. were hydraulically fractured. These unconventional wells have unique requirements and operating characteristics including water sourcing, management, treatment, transportation, and disposal. Water management represents up to 55% of unconventional production operations cost. Each new production well requires 5-15 million gallons of water for hydraulic fracturing, with 15-85% returning to the surface as contaminated flowback and produced water. Most water for hydraulic fracturing is sourced from freshwater aquifers with little oversight and regulation, while much of the shale resources are located in arid regions. In 2011, 55% of new wells were drilled in areas of high drought. Estimates project that from 2017 to 2026, a total of 20 billion barrels of water will be required to serve the U.S. hydraulic fracturing industry, with expenditures for water management totaling $136 billion over the same period. Current growth predictions for the industry are simply not sustainable when water resources are considered.

Today, approximately 90% of produced water is disposed of by injection in disposal wells or for enhanced oil recovery. The decreasing availability of disposal wells (due to induced seismicity), high cost of transportation and storage, and competition for water resources are providing strong impetus to develop affordable technology solutions for produced water treatment for beneficial re-use. Current practice for produced water re-use is limited by affordability. Most water is treated only for removing suspended solids before dilution with large quantities of fresh water to lower total dissolved solids (TDS) concentrations to levels compatible with gel and slickwater fracturing chemistries. Therefore, the costs of water sourcing, transportation, and storage of produced water still hamper the industry. The proposed technology is to target the removing high concentrations of TDS (>100,000 ppm) and hazardous pollutants from produced water for under $1.50 per barrel (capital and operations costs). Operating costs for unconventional oil and gas development could then be reduced by over 30% leading to greater, safer, unconventional development and energy independence.

Competing commercial technologies for produced water desalination include: reverse osmosis, forward osmosis, electrodialysis, membrane distillation, mechanical vapor compression, and multistage, multi-effect evaporation (Table 1). The cost per barrel of water for these technologies will vary on scale, quality of feed water, and availability of low grade heat, but range from $3.50 to $12.00 per barrel. Reverse osmosis can cost under $1.00/bbl; however, it is not applicable for produced water due to TDS limitations. Osmosis-based technologies tend to be limited in their ability to process water with TDS>100,000 ppm as is typical for shale oil and gas produced water and have limited ultimate water recovery. Membrane-based technologies have low recovery rates, typically producing a concentrated brine byproduct for disposal. While higher recoveries can be achieved with mechanical vapor compression or multi-stage evaporation systems, these technologies are capital intensive and lack the modularity benefits of the proposed technology. Moreover, current solutions lack zero liquids discharge capability, having byproduct streams with at best 300,000 ppm TDS. Lastly, thermal methods do not address volatile organic carbon emissions, such as BTEX (benzene, toluene, ethylbenzene and xylene) that can result from treating large volumes of produced water and release potentially tens of tons of hazardous air pollutants annually.

### SUMMARY OF THE INVENTION

The present invention relates generally to resolving water issues inherent in unconventional oil and gas development. The subject approach to eliminate produced water transportation and disposal uses an affordable, scalable, modular produced water treatment technology for under $1.50/bbl water using aerospace combustion and injection technology. This represents a transformational improvement over today's technologies which costs $3.50-$12.00/bbl water and are challenged by high total dissolved solids (TDS) concentrations, membrane fouling, dissolved gases, scalability and modularity, and are limited in total recovery.

The subject invention includes a non-fouling, direct contact steam generator for desalinating and removing hazardous pollutants from water produced during unconventional oil and gas development. The subject technology uses aerospace-derived wall wetting and water injection techniques to enable effective wall cooling, efficient and uniform water evaporation, and generation of a steam-laden flue gas from which solid contaminants can be easily separated as solid cake waste. Current and developing competing technologies such as membrane distillation and mechanical vapor distillation result in concentrated brines requiring brine crystallization or evaporation ponds.

The direct contact steam generator eliminates the need for further processing, transportation of hazardous brines, or injection wells. A preferred embodiment of this invention comprises a fully integrated system capable of treating approximately 20,000 bpd.

Further objects and advantages to the invention will be apparent from the following detailed description of preferred embodiments and from the accompanying drawings.

### BRIEF DESCRIPTION OF THE DRAWINGS

Objects and features of this invention will be better understood from the following description taken in conjunction with the drawings, wherein:

FIG. 1 is a schematic of a produced water treatment for re-use system according to one preferred embodiment of the invention;

FIG. 2 is a schematic of the subject system according to one preferred embodiment of the invention;

FIG. 3 is a schematic of the subject system according to one preferred embodiment of the invention;

FIG. 4 is a schematic of the subject system according to one preferred embodiment of the invention; and

FIG. 5 is a schematic of the subject system according to one preferred embodiment of the invention;

As will be appreciated, certain standard elements not necessary for an understanding of the invention may have been omitted or removed from the drawings for purposes of facilitating illustration and comprehension.

### DETAILED DESCRIPTION

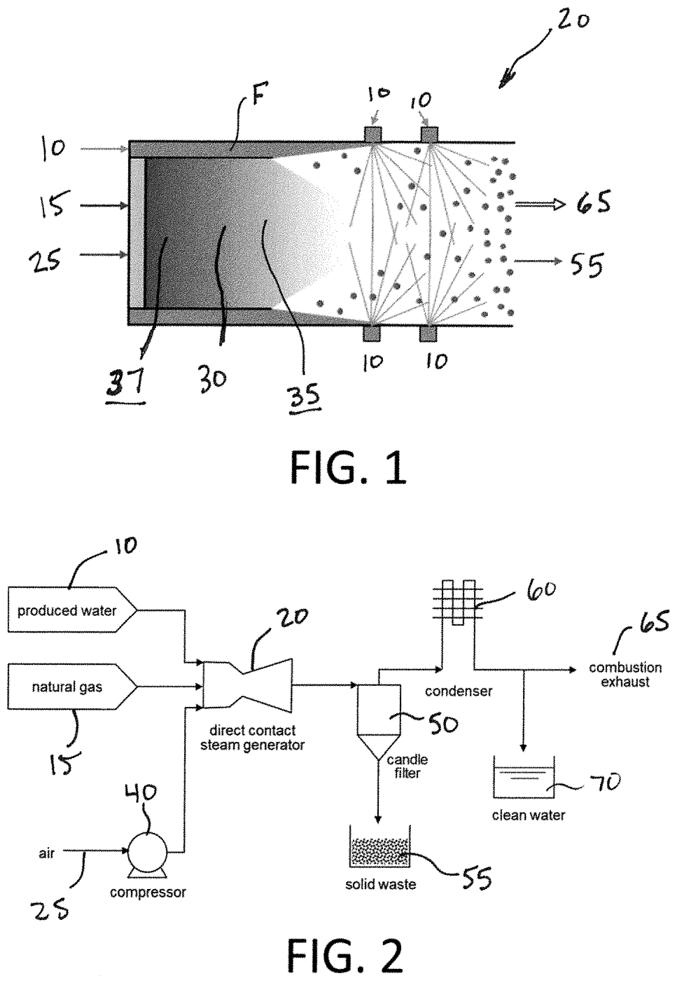

FIG. 1 illustrates a schematic of a produced water treatment for re-use (PWTR) system in accordance with one embodiment of the invention. The proposed produced water treatment for re-use (PWTR) technology is a non-fouling, direct contact steam generator that uses aerospace-derived combustion, film cooling, and water injection techniques to directly vaporize produced water. In FIG. 1, a core of the device is a gas/air combustor housed in a chamber. Although not required, the chamber may be a wall-wetted chamber. Produced water is preferably injected to cool the combustor chamber wall, while additional produced water is injected downstream of the chamber. The contaminants in the produced water are converted to solid particles entrained in the steam-laden flue gas.

FIGS. 2-5 show various preferred systems for removing solids through filtration, while the steam is condensed to recover the injected water along with water of combustion. The technology has the potential to be disrupt in the produced water treatment industry in several ways. The robust and versatile design allows the treatment of high TDS produced waters from a variety of wells. The system demonstrates high water recovery rates of over 100%, when the water of combustion is recovered. The system results in a zero liquids discharge design to generate a solids byproduct that can easily be trucked offsite. Volatile organic combustion within the system eliminates potential for hazardous emissions from produced water. Inherent modularity resulting from an aerospace-derived design makes solution scalable, allowing a wide range of sizes from small field units to large units serving central processing facilities. Finally, the system eliminates transportation and storage costs associated with produced water by providing on-site affordable technology to desalinate produced water.

FIG. 1 shows one embodiment of a steam generator with potential to desalinate produced water at a cost of under $1.50/bbl. The technology produces a clean desalinated water stream for beneficial re-use along with a solids waste stream. The low-cost, high water recovery and zero liquids discharge capabilities represent a transformational advancement in the field of unconventional oil and gas production.

The steam generator directly contacts produced water with high temperature flue gas to fully vaporize the water and generate solids, which can be easily separated. The vaporized water is preferably condensed and recovered as a clean condensate along with water of combustion. The heat source is a compact air/gas combustor based on rocket engine injector concepts, but designed for high combustion efficiency with low NOx emissions. The combustor is housed in a chamber that uses the produced water feed to provide wetted wall cooling, while supplemental water is injected downstream of the chamber.

Specifically, the steam generator 20 shown in FIG. 1 includes a combustion chamber 35 that has an inlet section 37. The inlet section 37 includes an oxidant feed 25 and a fuel feed 15. The oxidant feed 25 may be generated from a compressor 40 (not shown in FIG. 1). The oxidant feed 25 and the fuel feed 15 are understood to be physical structures that include piping or conduits and supply sources including, respectively, the fuel and the oxygen. In this example, the oxidant feed 25 is the exclusive oxidant feed of the combustion chamber 35 and the fuel feed 15 is the exclusive fuel feed of the combustion chamber 35. Thus, there are no additional oxidant feeds and the fuel feeds downstream from the inlet section 37 and all of the fuel and oxygen are provided into the combustion chamber 35 at the inlet section 37.

At least one produced water feed 10 is located downstream from the inlet section 37. Similar to the oxidant feed 25 and the fuel feed 15, the produced water feed 10 is understood to be a physical structure that includes piping or conduits and at least one supply source including produced water from a well or formation. In this schematic, two produced water feeds 10 are shown, although additional produced water feeds 10 could be used, depending on the designed stoichiometry of the steam generator 20.

A portion of the injected produced water can also serve to cool the combustion chamber 35. As an example, the produced water provides a water film F or combination of water film and cooled cooling circuit along the interior surfaces of the combustion chamber to cool the combustion chamber 35.

The innovative combustion, wall cooling, liquid injection, and rapid mixing attributes have been leveraged from aerospace combustor concepts. Because the produced water is directly contacted with the heat source, there are no coolant tube fouling issues encountered in indirectly heated boilers. Once the water is fully vaporized, the solid particles are removed in a filter, and the water is condensed to produce a desalinated stream available for re-use. Some of the water formed in the combustion process is also recovered, enabling water recovery rates of over 100%. The system includes a modular container-based design with a high degree of factory assembly to minimize field installation work. Because produced water contains hydrocarbons that would partition to the flue gas and be emitted to the atmosphere, the system utilizes a hydrocarbon removal system.

Referring to the schematic embodiments shown in FIGS. 2-5, a system for desalinating and removing pollutants from water produced during oil and gas development includes a discharge directing produced water 10 from a well.

There are several preferred options for solid waste separation and removal. One embodiment, as shown in FIG. 2, utilizes a candle filter 50 and a condenser 60 to separate solid waste from clean water. Alternatively, a cyclone filter may be used to remove solid waste. However, a final polishing filter, such as an electrostatic precipitator, is additionally preferred to remove >97-99% of the contaminants and any particles smaller than approximately 2 microns. Cyclone filters are useful for high solids loading, but the loading in this application is acceptable for candle filters. A high efficiency filter is preferred to prevent plugging/fouling of downstream hardware, such as a superheater or activated carbon bed, as described below.

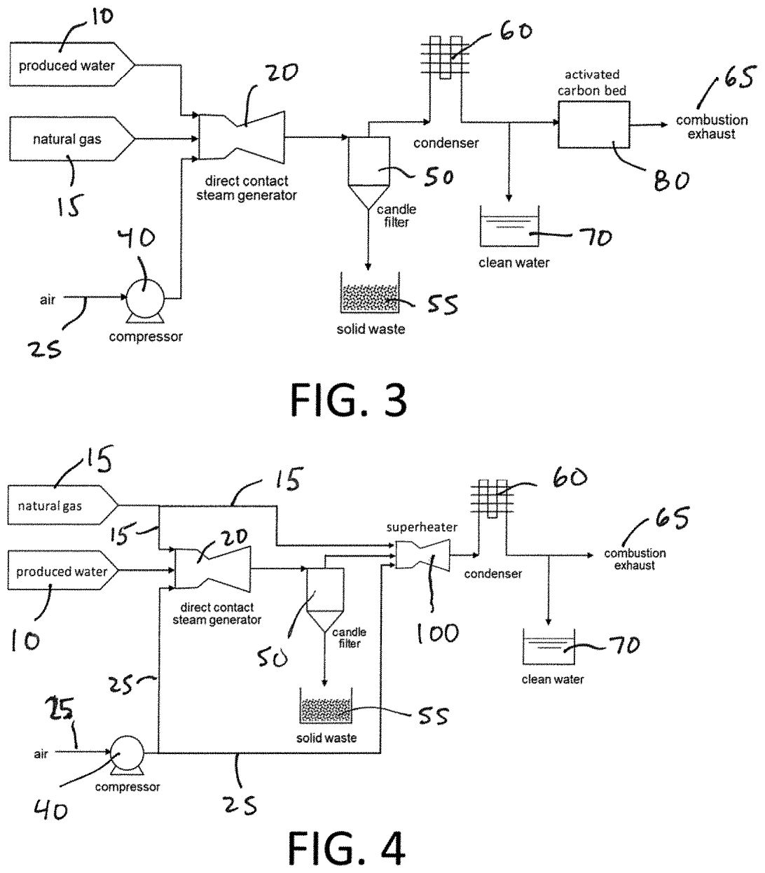

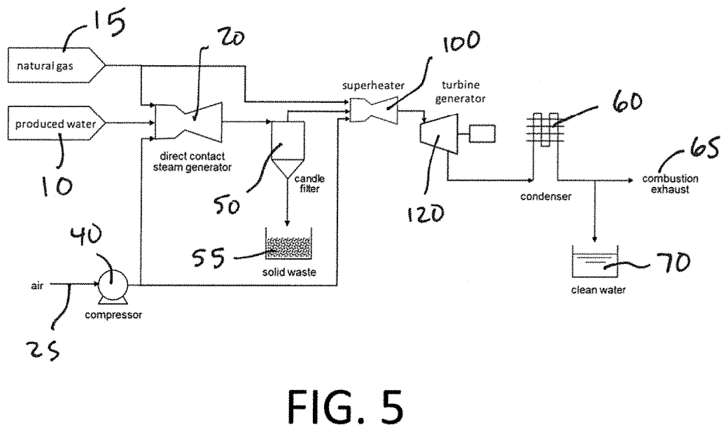

There are several preferred options for subsequent hydrocarbon removal of the combustion exhaust created from the condenser. One embodiment, as shown in FIG. 3, utilizes an activated carbon adsorption bed 80 to remove hydrocarbons and possibly other species such as arsenic, selenium, and heavy metals. FIG. 4 shows an alternative embodiment using a secondary combustor (superheater 100) downstream of the filter to burn out hydrocarbons and increase the energy in the exhaust stream. This option requires heat recovery from the high temperature exhaust to lower fuel usage. Heat can be recovered by preheating combustion air and/or preheating produced water. FIG. 5 is a further variation of a preferred system that additionally utilizes a turbine generator 120 to recover at least a portion of the energy utilized in the secondary combustor 100.

A direct contact steam generator 20, as described in more detail above, is preferably positioned downstream of the discharge to receive the produced water 10 into multiple inlets and/or nozzles. As described, the direct contact steam generator preferably comprises a gas/air combustor housed in a wall-wetted chamber. A fuel, such as natural gas 15, is also provided to the direct contact steam generator 20. In addition, an oxidant, such as compressed air from a compressor 40 may be provided to the direct contact steam generator 20.

A filter 50 is positioned downstream of the direct contact steam generator 20 to separate solid waste 55 from the produced water 10. According to a preferred embodiment, the filter 50 comprises a candle filter which separates and directs solid waste away from combustion products and steam. Alternatively, the filter 50 may comprise a cyclone filter. However, in such an embodiment, it may be desirable to add a polishing filter in series with the cyclone filter.

A condenser 60 is positioned downstream of the filter 50. The condenser separates combustion exhaust from clean water 70. This supply of clean water 70 may then be reused in well production or otherwise diverted to the source of the produced water within the well.

As shown in FIG. 3, in one embodiment, an activated carbon bed 80 is positioned downstream of the condenser 60. The activated carbon bed 80 preferably captures hydrocarbons and, potentially, heavy metals from the combustion exhaust created by the condenser 60.

As shown in FIG. 4, a secondary combustor, such as a superheater 100 is positioned between the filter 50 and the condenser 60. The superheater 100 may be provided with a common natural gas supply as the direct contact steam generator 20.

FIG. 5 shows an additional embodiment wherein a turbine generator 120 is placed between the superheater 100 and the condenser 60 to generate additional power for either well development operations or as surplus.

An associated method for desalinating and removing pollutants from water produced during oil and gas development, as described above includes discharging produced water from a well; providing a direct contact steam generator in a path of the produced water; providing a supply of natural gas and air to the direct contact steam generator; injecting the produced water through the direct contact steam generator; and directing combustion products, steam and solid contaminants from the direct contact steam generator through a candle filter to filter solid waste and to a condenser to generate clean water.

In additional embodiments, combustion products may be directed from the condenser through an activated carbon bed. Alternatively, or in addition, combustion products may be directed through a superheater prior to the condenser.

Test results demonstrate the potential of the technology to generate a clean condensate from water with TDS levels as high as 190,000 ppm. The design permits desalination of produced water from unconventional wells, will be air-fired, and will operate at lower pressures.

Benefits of the PWTR system allow evaporation of produced water from unconventional wells. A commercial-scale (nominal 20,000 bpd water) PWTR system is preferably capable of treating water at a cost under $1.50/bbl. This cost target was derived from a survey of competing state of the art technologies. These initial cost estimates were developed assuming $2/MMBtu fuel gas, $0.10/kWh power, and a 20% capital recovery factor. Although these cost estimates are indicative, they highlight the potential of the technology to desalinate produced water at a cost of under $1.50/bbl. A benefit of the technology is the high water recovery and zero liquid discharge capabilities. This can significantly reduce costs associated with water transportation and disposal. The widespread adoption of this technology can enable annual savings of >$1B by lowering water sourcing, transportation, storage, and disposal costs. This will have a significant impact on the cost of supply of unconventional resources in the U.S., open the door for energy independence, and reduce our reliance on foreign energy imports.

Challenges of the subject system are to avoid: filters that will not capture solids; hydrocarbons contamination of treated water; fouling of heat recovery heat exchanger with high TDS water; corrosion of heat exchanger materials; and high cost treatment/re-use of water.

The produced water is expected to have a variety of salts which precipitate differently. One advantage of a candle filter is the range of particle sizes facilitating cake removal. Initial filter and pore sizing are based on TDSs and droplet sizes.

A solids filtration system for the subject system may include one of two preferred methods for removing hydrocarbons present in the flue gas. The first utilizes an activated carbon bed in removing hydrocarbons along with species such as Arsenic, Selenium, and heavy metals (if present). The second utilizes a secondary combustor to oxidize hydrocarbons. The secondary combustor configuration requires feedwater preheating to lower natural gas usage since the higher temperature requires additional heat and therefore fuel consumption. Feedwater preheating recovers some of the additional heat for hydrocarbon burnout and improves system efficiency and reduces operational cost. Risks of this method include heat exchanger fouling and potential corrosion issues from the produced water.

The secondary combustion-based hydrocarbon removal option requires a high degree of heat recovery from the hot flue gas to lower fuel usage. The largest heat sink is the produced water stream. However, due to high TDS, hardness, and silica levels, this stream has a high propensity to foul heat exchangers.

There is a strong demand for affordable technology to clean up produced water for re-use in the unconventional oil and gas industry due to fresh water scarcity, ever more limited disposal options, and the high cost of produced water transport and storage ($13B annually by in 2018; FIG. 2). The continued rise of water transportation and treatment costs ($3.50-$12.00 per barrel of oil) in the U.S., reduces the nation's overall capacity to competitively produce oil and gas, resulting in an increased energy-related imports. To make a dramatic impact on reducing oil and gas production costs related to water treatment, the solution must be able to treat high TDS-water of over 100,000 ppm at a cost less than $1.50/bbl.

The DCSG is not a boiler, and the technology has been leveraged from the aerospace industry. The DCSG operates at a moderate pressure and temperature regime with carefully controlled water atomization in a compact area for fast evaporation and solids separation.

While in the foregoing detailed description this invention has been described in relation to certain preferred embodiments thereof, and many details have been set forth for purposes of illustration, it will be apparent to those skilled in the art that the invention is susceptible to additional embodiments and that certain of the details described herein can be varied considerably without departing from the basic principles of the invention.

Although specific advantages have been enumerated above, various embodiments may include some, none, or all of the enumerated advantages.

The invention illustratively disclosed herein suitably may be practiced in the absence of any element, part, step, component, or ingredient which is not specifically disclosed herein.

The claims are not intended to include, and should not be interpreted to include, means-plus- or step-plus-function limitations, unless such a limitation is explicitly recited in a given claim using the phrase(s) “means for” or “step for,” respectively.

What is claimed is:

1. A system for desalinating and removing pollutants from water produced during oil and gas development, the system comprising:
a discharge directing produced water;
a direct contact steam generator positioned downstream of the discharge;
a filter positioned downstream of the direct contact steam generator to separate solid waste from the produced water;
a condenser positioned downstream of the filter, the condenser separating combustion exhaust from clean water.

2. The system of claim 1 further comprising:
an activated carbon bed positioned downstream of the condenser.

3. The system of claim 1 further comprising:
a superheater positioned between the filter and the condenser.

4. The system of claim 3 further comprising:
a compressor providing direct air injection to the direct contact steam generator and the superheater.

5. The system of claim 4 further comprising:
a natural gas supply providing natural gas to the direct contact steam generator and the superheater.

6. The system of claim 1 wherein the direct contact steam generator comprises a gas/air combustor housed in a wall-wetted/cooled chamber.

7. The system of claim 1 wherein the direct contact steam generator further comprises a supply of produced water into a chamber and downstream of the chamber.

8. The system of claim 2 further comprising a turbine generator downstream of the superheater.

9. The system of claim 1 wherein the filter comprises a candle filter.

10. The system of claim 1 wherein the filter comprises a cyclone filter.

11. The system of claim 10 further comprising a polishing filter positioned downstream of the cyclone filter.

12. The system of claim 1 further comprising a turbine generator downstream of the direct contact steam generator.

13. The system of claim 1 wherein the produced water discharge is directed from a well.

14. A method for desalinating and removing pollutants from water produced during oil and gas development, the method comprising:
discharging produced water from a well;
providing a direct contact steam generator in a path of the produced water;
providing a supply of natural gas and air to the direct contact steam generator;
injecting the produced water through the direct contact steam generator; and
directing combustion products, steam and solid contaminants from the direct contact steam generator through a candle filter to filter solid waste and to a condenser to generate clean water.

15. The method of claim 14 further comprising:
directing combustion products from the condenser through an activated carbon bed.

16. The method of claim 14 further comprising:
directing combustion products and steam through a superheater prior to the condenser.

17. The method of claim 16 further comprising:
positioning a turbine generator downstream of the superheater.

18. The method of claim 16 wherein the supply of natural gas and air is also directed to the superheater.

19. A system for desalinating and removing pollutants from water produced during oil and gas development, the system comprising:
a discharge directing produced water from a well;
a direct contact steam generator positioned downstream of the discharge;
a filter positioned downstream of the direct contact steam generator to separate solid waste from the produced water;
a superheater positioned downstream of the filter;
a condenser positioned downstream of the superheater, the condenser separating combustion exhaust from clean water;
a compressor providing direct air injection to the direct contact steam generator and the superheater; and
a natural gas supply providing natural gas to the direct contact steam generator and the superheater.

20. The system of claim 19 further comprising:
a turbine generator positioned between the superheater and the condenser.

21. The system of claim 19 further comprising:
an activated carbon bed positioned downstream of the condenser.

22. The system of claim 19 wherein the filter comprises a candle filter.
